(19) United States
(12) Patent Application Publication
(10) Pub. No.: US 2004/0143620 A1
(43) Pub. Date: Jul. 22, 2004

(54) Intervening ip calls during a modem session

(76) Inventors: Abraham Fisher, Haifa (IL); Dror Meiri, Haifa (IL)

Correspondence Address: William H Dippert, Reed Smith, 29th Floor, 599 Lexington Avenue, New York, NY, 10022-7650, US

(21) Appl. No.: 10/478,027

(22) PCT Filed: May 20, 2002
(86) PCT No.: PCT/IL02/00390

(30) Foreign Application Priority Data
May 21, 2001 (IL) 143277

(51) Int. Cl. G06F 15/16

(52) U.S. Cl. 709/200

(57) ABSTRACT

A method of establishing an over-Internet-protocol (XoIP) call over a previously established connection path between a client and a remote access concentrator (RAC), while a currently active call is using the established connection path. The method includes transmitting a request to establish an XoIP call over the previously established connection path, moving the currently active call on the previously established connection path to a hold state, and establishing the requested XoIP call on a connection including the previously established connection path.

### FIELD OF THE INVENTION

The present invention relates generally to communication systems and in particular to modem systems.

### BACKGROUND OF THE INVENTION

Many users use their home telephone line to access the Internet. Generally, a telephone connection is established with an Internet server provider (ISP) and voice band modem (VBM) signals are transferred on the connection between a client computer and a remote access server (RAS) of the ISP. While the telephone line is connected to the RAS, the line cannot be used for other purposes, e.g., telephone calls and faxes. As connections to the RAS, for example for Internet access may have long durations, the blockage of the telephone line may be problematic.

The V.92 ITU recommendation, described, for example in ITU publication PCM-00-062R1, V.92 draft and proposed changes, November 2000, the disclosure of which is incorporated herein by reference, defines provisions for putting an Internet access call on hold so as to allow use of the telephone line for other purposes without disconnecting the Internet access connection. As is known in the art, when a request to establish a connection to a telephone line which is engaged in another connection is received by a central office (CO), the CO transmits a “call waiting” (CW) alert signal which notifies the user of the telephone line that a request to establish an incoming call has been received. If the telephone line is busy with a regular telephone service, the user hears an audio signal and may press a flash button on the telephone, so as to switch to the incoming call. If the telephone line is engaged in a V.92 modem connection, the client receives the CW alert signal and asks the user if he/she wishes to accept the call. If the user wants to receive the call, the ISP and client modem perform a modem on hold (MoH) procedure which puts the Internet access call on hold. Then, the CO servicing the client is signaled to switch to the incoming call. Similar provisions are defined by the V.92 protocol, to allow establishment of out-going calls while keeping the Internet access call on hold.

The increase in the availability of packet based networks and the relatively cheap cost of their maintenance has brought wide spread use of packet based networks for partial transfer of calls between two end users connected through switched networks. In such calls, the signals are passed from a first party of the call over a switched network to a generally nearby gateway. The gateway transfers the signals to a packet based format and passes them to a second gateway near a second party to the call. The second gateway converts the signals to a format suitable for transmission on a switched network for transmission to the second party. Such calls are referred to as voice over IP (VoIP), fax over IP (FoIP) and modem over IP (MoIP) calls, or together as XoIP calls.

Some ISPs, include a remote access concentrator (RAC) which serves both for handling Internet access calls and as a gateway for XoIP calls.

### SUMMARY OF THE INVENTION

An aspect of some embodiments of the present invention relates to a method of utilizing a connection path, between a remote access communicator (RAC) and a subscriber, carrying a first call, for transferring a second call between the RAC and the subscriber, without terminating the first call. In some embodiments of the invention, the first call is kept on hold using modem-on-hold provisions, such as defined in the V.92 recommendation, while the second call is in progress. Optionally, the second call comprises an in-coming or out-going XoIP call. In some embodiments of the invention, the first call comprises an Internet access call. Alternatively or additionally, the first call comprises an XoIP call.

There is therefore provided in accordance with an embodiment of the present invention, a method of establishing an over-Internet-protocol (XoIP) call over a previously established connection path between a client and a remote access concentrator (RAC), while a currently active call is using the established connection path, comprising transmitting a request to establish an XoIP call over the previously established connection path, moving the currently active call on the previously established connection path to a hold state, and establishing the requested XoIP call on a connection including the previously established connection path.

Optionally, moving the currently active call to a hold state comprises moving an Internet access call to a hold state. Optionally, moving the currently active call to a hold state comprises moving an XoIP call to a hold state. Optionally, establishing the XoIP call is performed without a central office (CO) on the previously established connection path performing a switching on the connection path. Possibly, transmitting the request to establish the XoIP call comprises transmitting the request over the previously established connection path from the client to the remote access concentrator (RAC). Optionally, transmitting the request to establish the XoIP call comprises transmitting the request responsive to a request of a user of the client to initiate an out-going call. Alternatively or additionally, transmitting the request to establish the XoIP call comprises transmitting the request responsive to a notification from the RAC that an in-coming call for the client was received by the RAC.

Optionally, the notification from the RAC that an in-coming call for the client was received by the RAC comprises a “call waiting” signal transmitted from the RAC.

There is further provided in accordance with an embodiment of the present invention, a method of handling an incoming over-Internet-protocol (XoIP) call by an Internet service provider (SP), comprising determining whether the incoming call is directed to a currently connected client, and forwarding a “call waiting” signal over an established connection to the client, from the ISP to the client.

Optionally, determining whether the incoming call is directed to a currently connected client comprises comparing a destination telephone number of the incoming call to a list of telephone numbers of clients currently connected to the ISP. Optionally, the method includes transmitting a subscriber alert signal (SAS) and/or a dual tone multi-frequency (DTMF) D signal from the client to the ISP. Optionally, the method includes transmitting a customer alerting signal (CAS) from the ISP to the client. Optionally, the method includes transmitting frequency shift keying (FSK) modulated signals between the ISP and the client. Optionally, the method includes transmitting at least one portion of caller identification information from the ISP to the client.

There is further provided in accordance with an embodiment of the present invention, an Internet service provider (ISP) system, comprising a remote access concentrator (RAC) adapted to establish connections with clients requesting access to a packet network, a network interface adapted to receive notifications on incoming calls which may be directed to clients connected to the RAC, and a processor adapted to determine for received notifications of incoming calls, whether the call is directed to a currently connected client, to identify an established connection to the client if the client is currently connected and to forward a “call waiting” signal over the established connection to the client.

Optionally, the system includes a memory listing telephone numbers of currently connected clients.

### BRIEF DESCRIPTION OF FIGURES

Exemplary non-limiting embodiments of the invention will be described with reference to the following description of embodiments in conjunction with the figures. Identical structures, elements or parts which appear in more than one figure are preferably labeled with a same or similar number in all the figures in which they appear, in which:

FIG. 1 is a communication network, useful in explaining an exemplary embodiment of the present invention;

FIG. 2 is a flowchart of the acts performed when an XoIP call is received from a remote client, in accordance with an exemplary embodiment of the present invention;

FIG. 3 is a time chart of the signals transmitted on a connection between a client and an ISP 106, during a modem on hold for XoIP procedure, in accordance with an embodiment of the present invention; and

FIG. 4 is a time chart of the signals transmitted on a connection between a client and an ISP, during a client call initiation procedure, in accordance with an exemplary embodiment of the present invention.

### DETAILED DESCRIPTION OF EMBODIMENTS

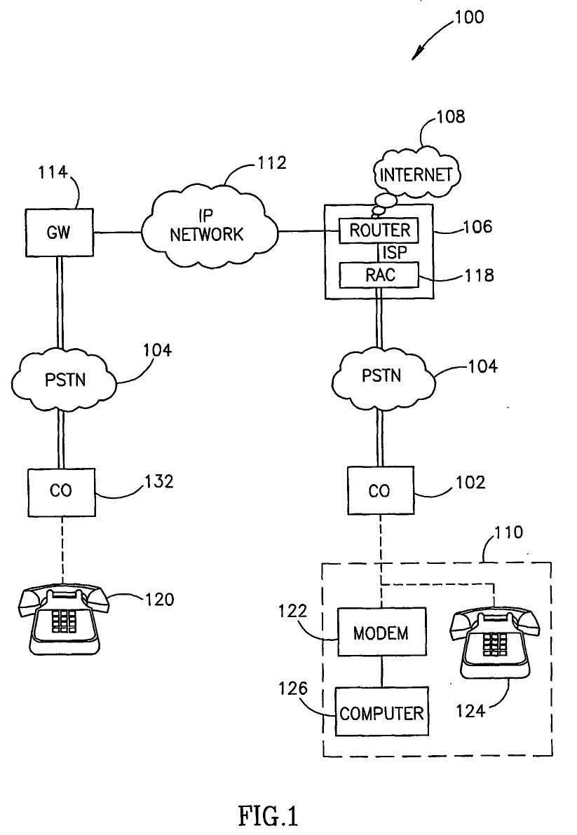

FIG. 1 is a schematic illustration of a communication network 100, useful in explaining an exemplary embodiment of the present invention. A client 110 is connected through a central office (CO) 102 to a public switched telephone network (PSTN) 104. Client 110 may connect through PSTN 104 to other telephone clients (not shown) or may connect to an Internet service provider (ISP) 106 which serves as a gateway to one or more IP networks, such as the Internet 108 and/or a VoIP dedicated network 112. Dedicated network 112 connects ISP 106 to other gateways, such as gateway 114, which interface to PSTN 104 (or to other PSTNs) at other points of interface than of ISP 106. For the following description, a second client 120, which connects to PSTN 104 near gateway 114, through a CO 132, is shown.

Alternatively to connecting through dedicated network 112, gateway 114 may connect to ISP 106 through a public IP network, e.g., the Internet. ISP 106 optionally comprises a remote access concentrator (RAC) 118 which is capable of handling XoIP calls, in addition to Internet access calls.

In some embodiments of the invention, client 110 includes a modem 122 and a telephone 124 which are connected to the telephone line in parallel, although the wire connection of telephone 124 may physically pass through modem 122, as is known in the art. In some embodiments of the invention, client 110 includes a computer 126 which connects to ISP 106 through modem 122. Alternatively or additionally, a switch controls which of modem 122 and/or telephone 124 are connected to the line.

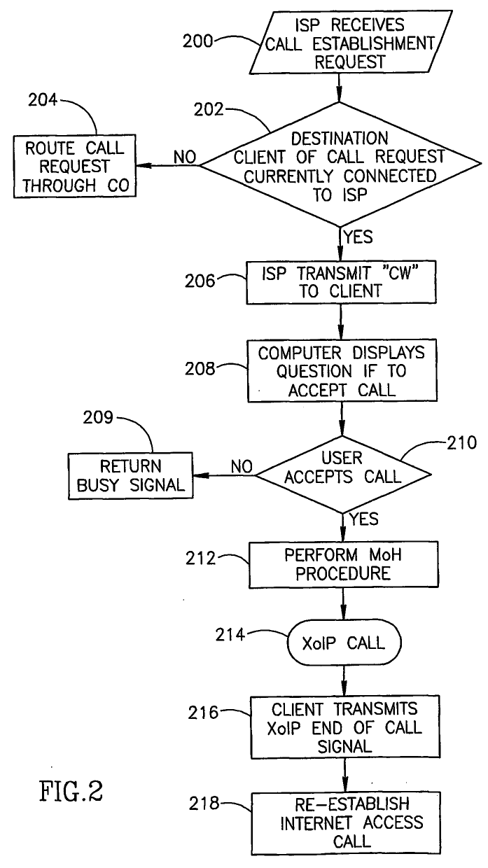

FIG. 2 is a flowchart of the acts performed by ISP 106 and client 110 when an XoIP call is received from a remote client (e.g., 120), in accordance with an exemplary embodiment of the present invention. When a request to establish an XoIP (e.g., VoIP, FoIP, MoIP) call is initiated by client 120, the request is transmitted to an ISP in the vicinity of client 110, optionally to ISP 106. In some embodiments of the invention, upon receiving (200) a request for establishing an XoIP connection, ISP 106 determines (202) whether the destination client of the call request is currently engaged in an Internet access call with ISP 106. If (202) the destination client is not currently connected to the ISP 106, the ISP 106 routes (204) the call request through CO 102, using methods known in the art.

In some embodiments of the invention, ISP 106 manages a list of the telephone numbers of the clients with which it is currently engaged in Internet access calls. Optionally, the request to establish a call includes the telephone number of the destination client, and determining (202) whether the destination client is currently connected to ISP 106 is performed by comparing the destination telephone number to the managed list. Alternatively or additionally, determination (202) is performed based on an ID number or any other client identification information.

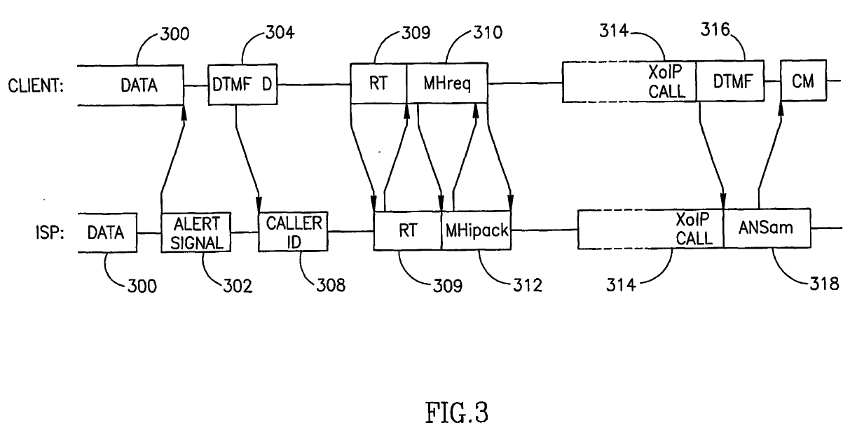

If (202), however, the destination telephone is currently connected to ISP 106, ISP 106 optionally transmits (206) a “call waiting” (CW) signal (e.g., a subscriber alert signal (SAS) signal) on the connection, notifying client 110 that a call request was received. In some embodiments of the invention, responsive to receiving the CW signal, computer 126 displays (208) a message to a user of client 110 asking if the XoIP call should be accepted. The display is optionally performed in an application window, such as described in the V.92 recommendation and/or using any other suitable method, such as a voice output. If (210) the user chooses not to accept the call, ISP 106 rejects (209) the request from client 120. Alternatively, ISP 106 redirects the call through CO 102. If (210) the user accepts the call, modem 122 initiates (212) a modem on hold for XoIP (MoHip) procedure, described in detail hereinbelow with reference to FIG. 3. Optionally, the user accepts or refuses the call by actuating a displayed control on computer 126 and/or any other input command, such as a user vocal command. In some embodiments of the invention, the actuation of the control is the only action required from the user in accepting the call. In some embodiments of the invention, if the user does not respond within a predetermined amount of time, the call is refused or accepted according to a predetermined default. In some embodiments of the invention, the user may choose to always receive the call, in which case, modem 122 responds to the request without asking the client and the reception of the call is performed automatically without user intervention. The MoHip procedure puts the current Internet access call on hold and uses the current connection for the requested XoIP call.

Reference is also made to FIG. 3, which is a time chart of the signals transmitted on the connection between client 110 and ISP 106, during a MoHip procedure, in accordance with an embodiment of the present invention. During the normal progression of the Internet access connection, client 110 and ISP 106 transmit to each other data signals 300. Upon receiving (200, FIG. 2) a request for establishing an XoIP connection with client 110, ISP 106 transmits (206) a CW signal 302 and optionally a customer alerting signal (CAS).

In some embodiments of the invention, modem 122 responds to the CAS signal with a DTMF D signal 304, as is known in the art. CO 102 will generally ignore the DTMF D signal, as it did not transmit a CW signal 302. Upon receiving the DTMF D signal 304, ISP 106 optionally transmits caller ID information 308, for example including frequency shift keying (FSK) modulated signals. Caller ID (CID) information 308 may be displayed to the user, for example by computer 126, allowing the user to determine whether to answer the call according to the caller ID. Thereafter, RT signals 309 are optionally exchanged between ISP 106 and modem 122, as described in the V.92 recommendation. Alternatively, modem 122 responds to CW signal 302 with RT signal 309.

Thereafter, modem 122 transmits a modem hold request signal (MHreq) 310, as defined in the V.92 protocol. It is noted that the modem hold request signal 310 is the same signal which is transmitted by modem 122 when a CW signal 302 is transmitted to modern 122 from CO 102. ISP 106 responds to modem hold request signal (MHreq) 310 with a MHipack signal 312, which notifies client modem 122 that the CW signal 302 was transmitted from ISP 106. In some embodiments of the invention, MHipack signal 312 is similar to the MHack signal defined in the V.92 protocol, for example having the same format but a different ID value in the type field.

After transmitting MHipack signal 312, ISP 106 puts the Internet access call on hold (e.g., transmitting an ANSam signal without a connection) and switches the requested XoIP call 314 through the current connection. At substantially the same time, client 110 switches (214, FIG. 2) to the requested XoIP call. If, for example, the XoIP call is a VoIP call, the user of client 110 lifts the hand-set of telephone 124 and carries out the call. In some embodiments of the invention, telephone 124 does not ring and the user answers the phone responsive to the notice on computer 126. Alternatively or additionally, computer 126 sounds a ringing sound which emulates the ringing of telephone 124. Further alternatively or additionally, computer 126 sends a control signal to telephone 124 which causes the telephone to ring.

In some embodiments of the invention, unlike in prior art modem-on-hold procedures, the user does not press the flash button on telephone 124 for the transfer, as CO 102 does not participate in, and optionally is not aware of, the call change.

If the call is a FoIP call or a MoIP call, the call may be handled by a fax machine or an additional modem (not shown) connected in parallel to modem 122 and telephone 124. Alternatively or additionally, the call may be handled by computer 126 through modem 122, which is instructed to wait for the call responsive to the user's instruction to accept the call.

Generally, the behavior of ISP 106 after transmitting MHipack signal 312 is the same as after transmitting the MHack signal known in the art, except that after the transmission of MHipack signal 312 the switching is performed by ISP 106, while after transmitting the MHack signal the switching is performed by CO 102 and ISP 106 only changes to transmitting an ANSam signal.

At the end of the XoIP call 314, client 110 optionally transmits (216, FIG. 2) a XoIP call termination signal 316 to ISP 106. Responsive to the XoIP call termination signal 316, ISP 106 optionally transmits an ANSam signal 318 and switches back to the Internet access call which was kept on hold, so as to re-establish (218) the Internet access call. Optionally, a quick connect procedure is performed at the return to the Internet access call, as described in the V.92 recommendation.

In some embodiments of the invention, XoIP call termination signal 316 comprises a predetermined telephone key sequence (e.g., *** or #*#) which is entered telephone 124 at the end of the XoIP call by the user. Alternatively, XoIP call termination signal 316 is generated by modem 122. Optionally, the modem generated XoIP call termination signal 316 includes one or more hidden signals, such as dual tone multi-frequency (DTMF) signals (e.g., A, B, C, D signals) and/or V.8 signals (e.g., CI, CT, CNG signals), which cannot be inadvertently generated by pressing keys of telephone 124. In some embodiments of the invention, the modem generated XoIP call termination signal 316 is generated responsive to a command entered by the user to computer 122, for example, a request to reinstall the Internet access call. Alternatively, the modem generated XoIP call termination signal 316 is generated automatically by modem 122 responsive to a determination that the XoIP call was completed. In some embodiments of the invention, modem 122 detects the completion of the XoIP call by detecting a silence period (for example due to hanging up the telephone 124) of beyond a predetermined time. Alternatively or additionally, when the XoIP call comprises a FoIP call or a MoIP call, modem 122 listens to the signals passing on the connection and identifies the call termination signals of the FoIP and MoIP calls. Alternatively or additionally, RAC 118 of ISP 106 identifies the termination of the call and notifies the client, for example by transmitting an ANSam signal on the connection.

Referring in more detail to determining (202) whether the destination client is currently connected to ISP 106, in some embodiments of the invention, a client may request to have all the calls routed through CO 102 even when a connection is currently active. Alternatively or additionally, a client may request that ISP 106 return a busy signal when a connection on the line is active.

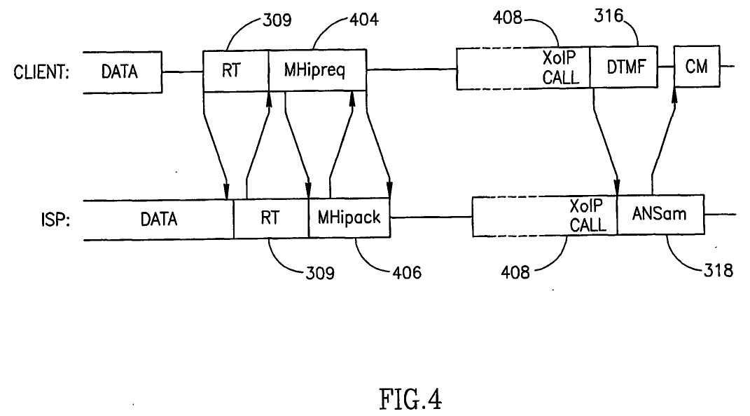

FIG. 4 is a time chart of the signals transmitted on the connection between client 110 and ISP 106, during a client call initiation procedure, while the client is connected to the Internet, in accordance with an exemplary embodiment of the present invention. When a user of client 110 wants to initiate an XoIP call through ISP 106, the user optionally actuates a respective control on computer 126. Alternatively or additionally, picking up the hand-set of telephone 124 is identified by computer 126. Optionally, telephone 124 has an external, switch which identifies the picking up of the hand-set and transmits a respective signal to computer 126.

Responsive to the control actuation, modem 122 transmits an RT signal 309 followed by a MHipreq signal 404 to ISP 106, requesting to perform the XoIP call. ISP 106 responds with an RT signal 309 followed by a MHipack signal 406 which acknowledges the request. Thereafter, the user initiates the XoIP call 408 which is switched by ISP 106 using methods known in the art. For example, the user lifts handset of telephone 124 and dials a destination telephone number. The XoIP call 408 is then optionally conducted and completed substantially as described above, regarding in-coming XoIP calls.

In some embodiments of the invention, when ISP 106 does not have unused ports for outbound XoIP calls and/or when client 110 is not entitled to perform XoIP calls through ISP 106, ISP 106 responds to MHipreq signal 404 with an MHack signal which indicates agreement to move the call on hold, without agreement to conduct the XoIP call. The user may then choose whether to conduct the call through CO 102 or to forgo the call.

ISP 106 optionally responds to MHipreq signal 404 substantially as it responds to an MHreq according to the V.92 recommendation, except that after the modem on hold procedure the switching is performed by ISP 106 and not by CO 102.

In some embodiments of the invention, if ISP 106 transmits an MHipack signal 406 to a client 110 which does not support the above described procedures, the client 110 will ignore the signal. Optionally, client 110 will initiate a retrain on the connection and will thus return to the current call. Similarly, in some embodiments of the invention, if client 110 transmits an MHipreq signal 404 to an ISP 106 which does not support the above procedures, the ISP 106 will ignore the signal.

In some embodiments of the invention, when ISP 106 receives an in-coming XoIP call destined to client 110, while an XoIP call with client 110 is already being handled by ISP 106, ISP 106 returns a busy signal. Alternatively, ISP 106 routes the in-coming call through CO 102. Further alternatively, ISP 106 allows the user to move the current XoIP call on hold in order to accept the in-coming call. Optionally in this alternative, when the call request is received, a dedicated alert signal is transmitted to client 110. In some embodiments of the invention, the dedicated alert signal is identified by computer 126 through modem 122, which alerts the user, for example, by a display and/or alert signal, of the in-coming call. Alternatively or additionally, modem 122 transmits a buzz sound on the line which is audible to the user but does not interfere with the operation of CO 102.

In some embodiments of the invention, ISP 106 can manage substantially any number of on-hold calls with a client 110. Optionally, a user interface on computer 126 allows the user to select the order in which to return to the on-hold calls after the completion of one of the calls. Alternatively or additionally, the user may switch between the calls by moving the current call into an on-hold state. Switching between the calls is optionally performed in a manner similar to that of initiating an out-going call, however, instead of providing a telephone number the user provides an ID (optionally through a graphic user interface) of the on hold call to which the user wants to return.

It is noted that in addition to managing concurrently a few calls through ISP 106, the user may manage an additional concurrent call, optionally a conference call, through CO 102.

In some embodiments of the invention, ISP 106 has different behaviors for different clients 110. Optionally, the user of client 110 may set the behavior of ISP 106 relating to the client.

The above description was brought by way of example with reference to the V.92 recommendation. It is noted that the present invention may be used in relation to other methods including other public protocols and/or proprietary methods. Furthermore, the transmission of control signals on V.92 connections is not limited to the above described signals. Rather, substantially any control signal transmitted to clients from a network, which do not cause CO 102 to disconnect the call, may be transmitted from ISP 106 to the client, for example a message notifying that a message (e.g., e-mail, voice mail) is awaiting the client.

It will be appreciated that the above described methods may be varied in many ways, including, performing a plurality of steps concurrently, changing the order of steps and changing the exact implementation used. It should also be appreciated that the above described description of methods and apparatus are to be interpreted as including apparatus for carrying out the methods and methods of using the apparatus.

The present invention has been described using non-limiting detailed descriptions of embodiments thereof that are provided by way of example and are not intended to limit the scope of the invention. It should be understood that features and/or steps described with respect to one embodiment may be used with other embodiments and that not all embodiments of the invention have all of the features and/or steps shown in a particular figure or described with respect to one of the embodiments. Variations of embodiments described will occur to persons of the art.

It is noted that some of the above described embodiments may describe the best mode contemplated by the inventors and therefore may include structure, acts or details of structures and acts that may not be essential to the invention and which are described as examples. Structure and acts described herein are replaceable by equivalents which perform the same function, even if the structure or acts are different, as known in the art. Therefore, the scope of the invention is limited only by the elements and limitations as used in the claims. When used in the following claims, the terms “comprise”, “include”, “have” and their conjugates mean “including but not limited to”.

1. A method of establishing an over-Internet-protocol (XoIP) call over a previously established connection path between a client and a remote access concentrator (RAC), while a currently active call is using the established connection path, comprising:
transmitting a request to establish an XoIP call over the previously established connection path;
moving the currently active call on the previously established connection path to a hold state; and
establishing the requested XoIP call on a connection including the previously established connection path.

2. A method according to claim 1, wherein moving the currently active call to a hold state comprises moving an Internet access call to a hold state.

3. A method according to claim 1, wherein moving the currently active call to a hold state comprises moving an XoIP call to a hold state.

4. A method according to any of the preceding claims, wherein establishing the XoIP call is performed without a central office (CO) on the previously established connection path performing a switching on the connection path.

5. A method according to any of the preceding claims, wherein transmitting the request to establish the XoIP call comprises transmitting the request over the previously established connection path from the client to the remote access concentrator (RAC).

6. A method according to any of the preceding claims, wherein transmitting the request to establish the XoIP call comprises transmitting the request responsive to a request of a user of the client to initiate an out-going call.

7. A method according to any of claims 1-5, wherein transmitting the request to establish the XoIP call comprises transmitting the request responsive to a notification from the RAC that an in-coming call for the client was received by the RAC.

8. A method according to claim 7, wherein the notification from the RAC that an in-coming call for the client was received by the RAC comprises a “call waiting” signal transmitted from the RAC.

9. A method of handling an incoming over-Internet-protocol (XoIP) call by an Internet service provider (ISP), comprising:
determining whether the incoming call is directed to a currently connected client; and
forwarding a “call waiting” signal over an established connection to the client, from the ISP to the client.

10. A method according to claim 9, wherein determining whether the incoming call is directed to a currently connected client comprises comparing a destination telephone number of the incoming call to a list of telephone numbers of clients currently connected to the ISP.

11. A method according to claim 9 or claim 10, comprising transmitting a subscriber alert signal (SAS) from the ISP to the client.

12. A method according to any of claims 9-11, comprising transmitting a dual tone multi-frequency (DTMF) D signal from the client to the ISP.

13. A method according to any of claims 9-12, comprising transmitting a customer alerting signal (CAS) from the ISP to the client.

14. A method according to any of claims 9-13, comprising transmitting frequency shift keying (FSK) modulated signals between the ISP and the client.

15. A method according to any of claims 9-14, comprising transmitting at least one portion of caller identification information from the ISP to the client.

16. An Internet service provider (ISP) system, comprising:
a remote access concentrator (RAC) adapted to establish connections with clients requesting access to a packet network;
a network interface adapted to receive notifications on incoming calls which may be directed to clients connected to the RAC; and
a processor adapted to determine for received notifications of incoming calls, whether the call is directed to a currently connected client, to identify an established connection to the client if the client is currently connected and to forward a “call waiting” signal over the established connection to the client.

17. A system according to claim 16, comprising a memory listing telephone numbers of currently connected clients.
